(19) United States
(12) Patent Application Publication
(10) Pub. No.: US 2009/0178575 A1
(43) Pub. Date: Jul. 16, 2009

(54) BROILER, CONVEYOR OVEN, AND TOASTER SYSTEM WITH PRESSURIZED AIR GUIDE FOR HEAT AND FLAMES

(75) Inventors: Edward Baker, Winsor, CA (US); Matthew Baker, Winsor, CA (US); Patrick Baker, Winsor, CA (US); Mohsen Sarfehjoo, Franklin, TN (US); Erik Magne, Fort Wayne, IN (US)

Correspondence Address: STAINBROOK & STAINBROOK, LLP, 412 AVIATION BOULEVARD, SUITE H, SANTA ROSA, CA, 95403, US

(73) Assignee: NIECO CORPORATION, WINDSOR, CA (US)

(21) Appl. No.: 12/410,012

(22) Filed: Mar. 24, 2009

Related U.S. Application Data
(63) Continuation-in-part of application No. 11/849,854, filed on Sep. 4, 2007.
(60) Provisional application No. 60/824,419, filed on Sep. 1, 2006.
(60) Provisional application No. 61/144,693, filed on Jan. 14, 2009.

(51) Int. Cl. A47J 37/04; A47J 37/06

(52) U.S. Cl. 99/401; 99/385; 99/447; 126/41 R; 126/15 R

(57) ABSTRACT

A cooking system using a pressurized air system combined with one or more gas or electric heating elements, including an air plenum connected to a source of pressurized air and having one or more arrays of air outlets that produce focused forced air curtains to confine and guide heat from the heating element to the food product.

### CROSS REFERENCES TO RELATED APPLICATIONS

The present application is a continuation-in-part of U.S. Utility patent application Ser. No. 11/849,854, filed Sep. 4, 2007 (Sep. 4, 2007), which claims the benefit of the filing date of U.S. Provisional Patent Application Ser. No. 60/824,419, filed Sep. 1, 2006 (Sep. 1, 2006); and further claims the benefit of the filing date of U.S. Provisional Patent Application No. 61/144,693, filed Jan. 14, 2009 (Jan. 14, 2009).

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT Disc

Not applicable.

### BACKGROUND OF THE INVENTION

1. Field of the Invention

The present invention relates generally to gas and electric burners for use in the rapid cooking of food products in broilers, conveyor ovens, non-conveyor ovens having a fixed oven cavity, and toaster systems, and more particularly to a novel burner and/or heating element that cooperate with a pressurized air unit that facilitates the introduction of pressured air into a regions proximate the burner and/or heating element to guide heat and/or flames to areas around and onto food product in a multi-source cooking system. The burner/heating element and pressurized air system are adapted for use in commercial broilers, conveyor ovens, and toasters for cooking a variety of food products through the combination of at least radiant and forced convection heat.

2. Discussion of Related Art Including Information Disclosed Under 37 CFR §§1.97, 1.98

To prepare certain foods, such as hamburger patties, sausages, hot dogs, pizza, toasted sandwiches, chicken and fish fillets, and the like, as well as their respective buns, high output commercial food purveyors (i.e., fast food restaurants) utilize broiler, oven, and toaster systems that rapidly and continually cook the food products. (As used herein, the term “cooking system” specifically covers broilers, ovens, and toasters, and is intended to include one or more of such systems independently and combined.) The systems typically comprise a housing (or cooking chamber) having a horizontal conveyor for moving food product from an input end to an output end. During the cooking process the food passes between a number of spaced-apart heating elements, typically either electric resistance elements or gas burners. As may be readily appreciated, the profitability of utilizing such a system hinges on a number of factors, including the rapidity and efficiency with which the food product can be cooked, the minimization of energy and/or fuel utilized in cooking, the ease with which the system can be serviced and cleaned, the quality (and therefore desirability) of the cooked food products, and so forth.

The present invention improves on prior art cooking systems by providing a novel gas or electrical heating element that introduces an air curtain of forced air around burner flames, or radiant heat from electric heating elements, in order to confine and direct the flames and heat downwardly onto food product, thus minimizing heat loss due to rising hot air, and to increase burner efficiency by providing a source of oxygen around and into the gas flame. The burner may include a shroud that provides heat reflecting surfaces (i.e., radiant heat/infrared heating elements) used in connection with the gas or electric burner. The shroud is disposed between the gas burner or electric heating element and the air plenum through which pressurized air is provided and preferably includes wing portions extending outwardly from the gas burner or electric heating element. This creates an effective combination of focused forced-convection and radiant heat in a cooking system. The system provides energy efficient rapidly cooked food products of uniform doneness, high quality, and desired moisture content.

Several rapid cooking systems have been developed for use in the fast food industry, including those described in the following U.S. patents.

U.S. Pat. No. 4,936,286, to Baker, discloses a broiler system having at least two side-by-side broiling conveyors, and broiler units mounted adjacent to the conveyors extending across the combined widths of the two conveyors. To permit different heating conditions on the two conveyors while still permitting the broiler units to be interchangeable and made of interchangeable parts, a broiler unit is provided with a shield which blocks off the heated face of the broiler unit where the broiler unit faces one of the conveyors. The shield preferably carries a portion which extends towards the adjacent edges of two conveyors to prevent lateral heat radiation between the conveyors.

U.S. Pat. No. 4,188,868, to Baker et al, shows a broiler system having a food passageway restricted by baffles, including an entrance shield of heat-reflecting material formed as a fitting over the entrance burner housing and including a baffle sheet extending from the entrance burner housing through most of the gap toward the entrance opening, and an exit shield of similar heat-reflecting material formed as a fitting over the exit burner housing and having a baffle sheet extending from the exit burner housing through most of the gap toward the exit opening. In addition, there is an intermediate shield including a horizontal sheet of similar material resting on adjacent burner housings and having a vertical sheet depending from said horizontal sheet. The entrance shield, the exit shield and the intermediate shield define the upper limits of the passageway through the burner and tend to reflect heat away from the entrance and exit openings and to limit air circulation within and through the passageway.

U.S. Pat. No. 4,121,509, to Baker et al., teaches a housing having a passageway through which a continuous food conveyor operates, taking food products from an inlet end to an outlet end. Within the passageway the food products are exposed to infrared radiation from heaters, hot air blown from a fan through a supply duct and through groups of nozzles onto the patties, and steam or hot water vapor provided through the air supply. By using three different types of heat supply—direct infrared radiation, warm air, and water vapor - the system provides a quickly cooked food product having a relatively high moisture content.

U.S. Pat. No. 3,987,718 to Lang-Ree et al., discloses a hamburger patty and bun cooker having a frame supporting lower and upper heated platens. A product conveyor, typical of such systems, moves food product from the inlet to the outlet. At least one of the platens is provided with a low-friction layer between it and an advancing patty. The layer is constituted by jets of hot air discharged over the platen surface or by a Teflon-coated thin, metal foil sheet or by a Teflon-carrying thin, fiber glass sheet, the sheets being readily changeable. Bun portions for the individual patties are advanced on the same frame in paths parallel to the hamburger patties by comparable endless conveyors and are heated by individual platens on the frame as the bun portions advance.

The foregoing patents reflect the current state of the art of which the present inventors are aware. Reference to, and discussion of, these patents is intended to aid in discharging Applicants' acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### SUMMARY OF THE INVENTION

The present invention is an improved heating unit for focused forced-convection and radiant heating d cooking system. The heating unit preferably employs a gas burner element or radiant electric element as the principal heat source. Using either gas or electricity, the heating unit includes several novel elements. Most notable among those novel elements is the provision and use of a pressurized air system employed during one or more stages of the cooking. The present invention combines convective air and radiant heat into a unified burner system that incorporates a pressurized air system to guide and direct focused heat and/or flames to create an energy efficient air curtain that impresses and impinges heat onto cooking food product. The heated air comprises the focused forced-convective characteristics of the cooking system, while the hot burners and surrounding over architectures provide a radiant heat source. The balance of heating effects can be instantaneously tailored and regulated by adjusting the air pressure itself. When air pressure is reduced, the convection air stream is reduced, and more heat will therefore be employed to increase burner bottom surface temperature, thereby increasing the contribution by radiant heat. Less immediate, but similarly flexible adjustments and tailoring, can be accomplished by modifying the shape, number, orientation, and spacing of each or both of the air outlet nozzles and the burner outlet nozzles. In such a manner, the cooking characteristics of the oven can be matched to the ideal cooking conditions for the cooked foods produced by the user.

Moreover, the inventive system, which combines a unique burner design, controls pressurized air forced through an outlet system to create an air curtain that focuses, guides and confines heat from electric heating element or gas burners and/or flames. This unique design provides an efficient transfer of heat and energy from the heating source (heating elements and heat reflective structures) to the food products. The protective air curtain provided by the pressurized air system focuses and directs heat in such a way that total heat is minimized as it is directed onto the product and not into the oven or cooker generally. This design accordingly will also minimize heat loss from the cooking chamber.

A first preferred embodiment of the inventive system includes a unit employing a gas burner element, in which there is provided a generally cylindrical gas pipe having gas outlets along the right and left sides of its entire length. The pipe may be any of a number of shapes and configurations, and when a conventional round pipe is used, the gas outlets are preferably disposed at roughly the 3 o'clock and 9 o'clock positions or the 4 o'clock and 8 o'clock positions, though it will be appreciated that the outlets may be oriented in any of a number of suitable positions, and there is no requirement that they be linearly aligned along the length of the burner or that they are provided along the entire length of the burner. An air plenum is disposed over the burner element substantially the entire length of the element, and pressurized air (i.e., higher than ambient pressure) is pumped into the plenum. In the first preferred embodiment, the plenum comprises an upper and a lower U-shaped channel which may be discrete and attached or either formed integrally, and it includes two arrays of air outlet nozzles either integrally formed within the plenum or comprising two L-shaped nozzle plates interposed between the lower and upper U-shaped channels at each side of the plenum. In either arrangement, the row or linear array of shaped orifices allow pressurized air to pass outwardly and downwardly from the plenum. In alternative embodiments, the plenum may be configured in shapes other than U-shaped to position air outlet nozzles on only one side of the heating element(s). The arrays are therefore disposed on either one or both sides of the heating element(s). In the case of gas burners, the air outlet nozzles are oriented in an array which is generally parallel to the gas orifices in the burner element. Each of the gas orifices may be matched with a proximate air orifice, though the match in number is not essential. The most important characteristic is that the air outlet array provide an effective air curtain to contain and direct heat. Accordingly, the inventive apparatus provides pressurized air that passes through the air orifices in thin jets from the plenum and around the gas flames. Thus, the heat from the flames, as well as the flames themselves, are directed downwardly toward the food product by the moving air streams. When used to cook food products, the hot air moved in this fashion breaks up the water vapor envelope that typically covers and insulates the food product as it initially thaws and/or evaporates water and begins heating. When used with thawed food product, the hot air evaporates water and begins heating. This use of hot air facilitates faster cooking and enhances browning. The air also facilitates complete oxidation of the gas fuel, thereby increasing efficiency, saving on energy costs, and reducing pollution. The air jets will help the heat penetrate the food product to improve heating of interior portions of the food.

The gas burner element in the first preferred embodiment of the inventive system additionally includes a novel wing or shroud design that directs and distributes gas flames so as to spread the heat provided by the elements and to create a radiant heating surface on the underside of the shroud.

In another embodiment, the gas burner may be replaced with an electric heating element. The configuration of the air plenum may be modified in a number of ways to better cooperate with the heat distribution characteristic of the particular electric elements employed, the oven cavity shape, the over interior, burner, and plenum materials and therefore the radiant heating characteristics, and the conveyor system or lack thereof. Otherwise, the compressed air system, including the plenum, is essentially identical in its essential purpose and function.

In addition, the air plenum contains a certain volume of heated air that serves as energy storage. In case a cooking system was put in a hibernating or energy saving mode with the burners or heating elements in a reduced power condition and with the air flow to the air plenum set to low or shutoff, the energy stored in the heated air of the air plenum can be used to quickly restart cooking and return it to full operating conditions.

The size of the air plenum is significant for sustained heat recovery of a cooking system during high load/high quality cooking. The larger the air plenum, the easier it is for a cooking system to recover.

An air plenum may be for a single burner (element), or multiple burners (elements).

An air plenum may also use re-circulated heated air. In this case, heated air would be taken from the cooking chamber and then returned to the air plenum via an air blower or venturi heat-inducing system for increased energy efficiency.

Many cooking systems have cool edges due to heat losses at the extremities of the cooking surface. The air plenum box orifice holes can be customized to even out the cooking of product by compensating for the loss of heat with additional hot air directed into the cool areas.

The orifices of the air plenum for the air jets can also be used to introduce sear marks or other random or unique pattern dark markings on the food.

Alternatively, distinctive sear or dark marks can be eliminated by different configuration of the orifice holes and air pressure adjustment.

The foregoing summary broadly sets out the more important features of the present invention so that the detailed description that follows may be better understood, and so that the present contributions to the art may be better appreciated. There are additional features of the invention that will be described in the detailed description of the preferred embodiments of the invention which will form the subject matter of the claims appended hereto.

Accordingly, before explaining the preferred embodiment of the disclosure in detail, it is to be understood that the disclosure is not limited in its application to the details of the construction and the arrangements set forth in the following description or illustrated in the drawings. The inventive apparatus described herein is capable of other embodiments and of being practiced and carried out in various ways.

Also, it is to be understood that the terminology and phraseology employed herein are for descriptive purposes only, and not limitation. Where specific dimensional and material specifications have been included or omitted from the specification or the claims, or both, it is to be understood that the same are not to be incorporated into the appended claims.

As such, those skilled in the art will appreciate that the conception, upon which this disclosure is based may readily be used as a basis for designing other structures, methods, and systems for carrying out the several purposes of the present invention. It is important, therefore, that the claims are regarded as including such equivalent constructions as far as they do not depart from the spirit and scope of the present invention. Rather, the fundamental aspects of the invention, along with the various features and structures that characterize the invention, are pointed out with particularity in the claims annexed to and forming a part of this disclosure. For a better understanding of the present invention, its advantages and the specific objects attained by its uses, reference should be made to the accompanying drawings and descriptive matter in which there are illustrated the preferred embodiment.

### BRIEF DESCRIPTION OF THE DRAWINGS

The invention will be better understood and the objects of the invention will become apparent when consideration is given to the following detailed description thereof. Such description makes reference to the annexed drawings wherein:

FIG. 1A is an exploded lower front end perspective view showing the general elements comprising the combined pressurized air plenum and burner of the inventive burner with the pressurized air heat and flame guide;

FIG. 1B is a lower front end perspective view showing the elements of FIG. 1A in the assembled configuration;

FIG. 2A is a cross-sectional front end view in elevation showing the burner flame pattern as affected by the air output from the air plenum, the view taken along section line 2A-2A of FIG. 1B;

FIG. 2B is an exploded cross-sectional front end view in elevation of the apparatus of FIG. 2A;

FIG. 3A is an exploded cross-sectional side view in elevation showing the elements of a complete broiler system using the inventive burner and pressurized air heat and flame guide of the present invention;

FIG. 3B is a cross-sectional side view showing the elements of FIG. 3B assembled;

FIG. 4 is a cross-sectional top plan view thereof taken along section line 4-4 of FIG. 3B;

FIG. 5A is an exploded cross-sectional end view showing a first preferred embodiment of the air plenum with nozzle plate assembly;

FIG. 5B is cross-sectional end view showing an alternative embodiment of the air plenum and nozzle plate;

FIG. 6 is a top plan view of a nozzle plate shown before bending along the bend line;

FIG. 6A is a partial top plan view showing an alternative nozzle opening shape;

FIG. 6B is a partial top plan view showing yet another alternative nozzle opening shape;

FIG. 7 shows an L-shaped nozzle plate with a plurality of nozzles;

FIG. 8 is a cross-sectional top plan view showing the assembled air plenum and nozzle plates;

FIG. 9 is a cross-sectional side view in elevation thereof,

FIG. 10 is a schematic cross-sectional end view in elevation showing the functional elements of the inventive system and highlighting the operative principles;

FIGS. 11-14 are each schematic cross-sectional end views in elevation showing alternative plenum configurations and air outlet arrays for use with one or more gas burners;

FIG. 15 is a schematic cross-sectional end view in elevation showing the same plenum configuration and air outlet array as that of FIGS. 2A and 2B, but combined with one or more infrared heating elements;

FIGS. 16-20 show various air plenum configuration and air outlet arrays used with side-by-side parallel electric resistance heating elements;

FIG. 21 is a cross-sectional side view in elevation showing a single/combined plenum with an air outlet manifold disposed on its underside for use with one, two or more gas burner and electric heating elements (shown with electric heating elements);

FIG. 22 is a cross-sectional side view in elevation of a possible burner/plenum configuration installed in a multistage conveyor oven using magnetic induction, convection and radiant heat whereas upper and lower burners or heating elements can be installed on top of each other or off-centered (shown gas burners off-centered); and

FIG. 23 is cross-sectional end view in elevation showing an alternative air plenum having an interior baffle system.

### DETAILED DESCRIPTION OF THE INVENTION

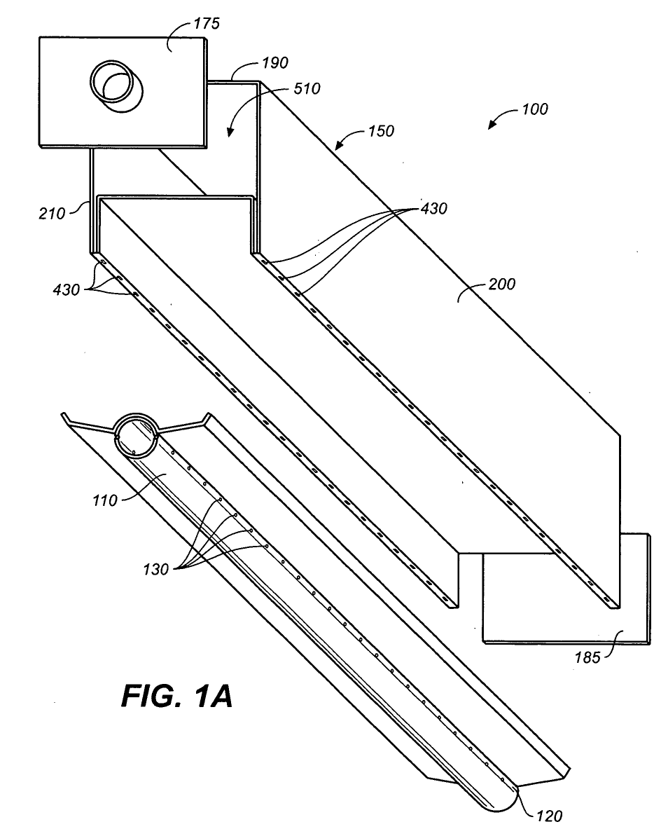

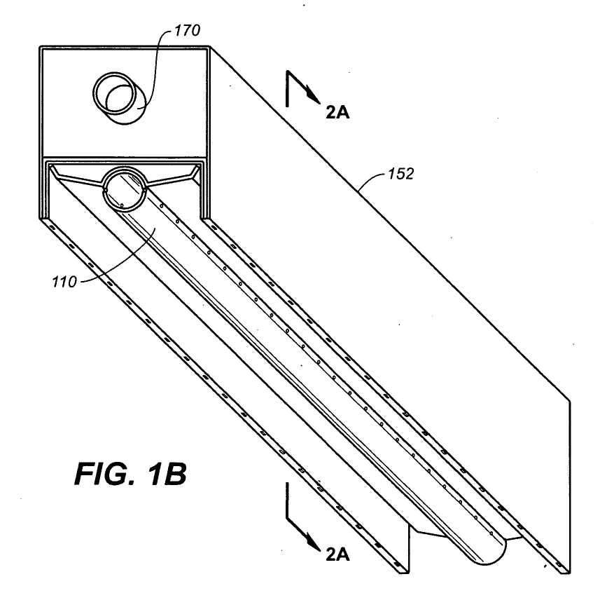

Referring to FIGS. 1 through 23, wherein like reference numerals refer to like components in the various views, there is illustrated therein a new and improved cooking system having a heating element, such as a gas burner or electric resistance heating element, and a pressurized air heat and flame guide for focusing and guiding the heat and/or flames produced by the heating element. A first preferred embodiment of the present invention is generally denominated 100 herein.

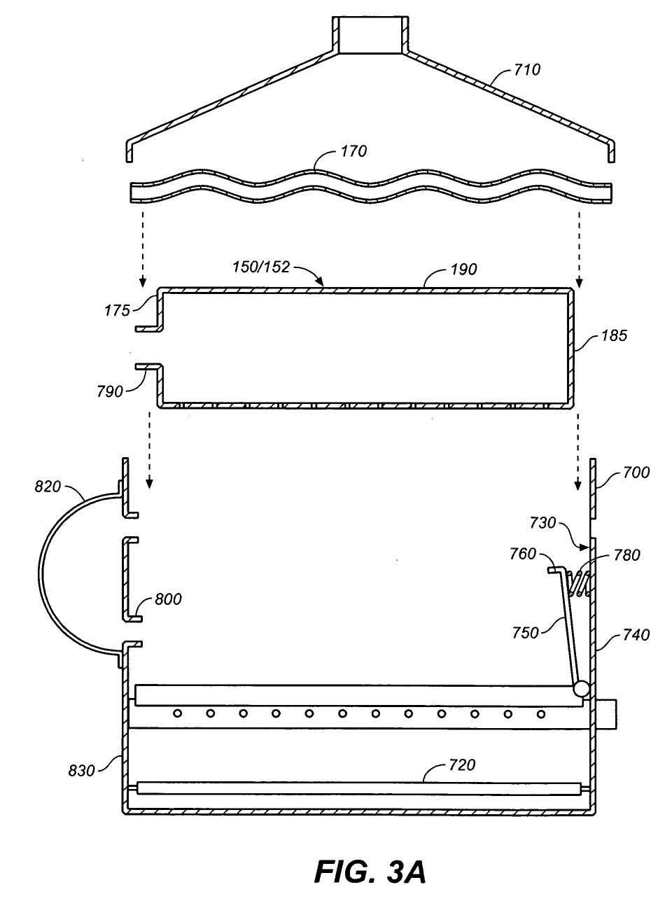

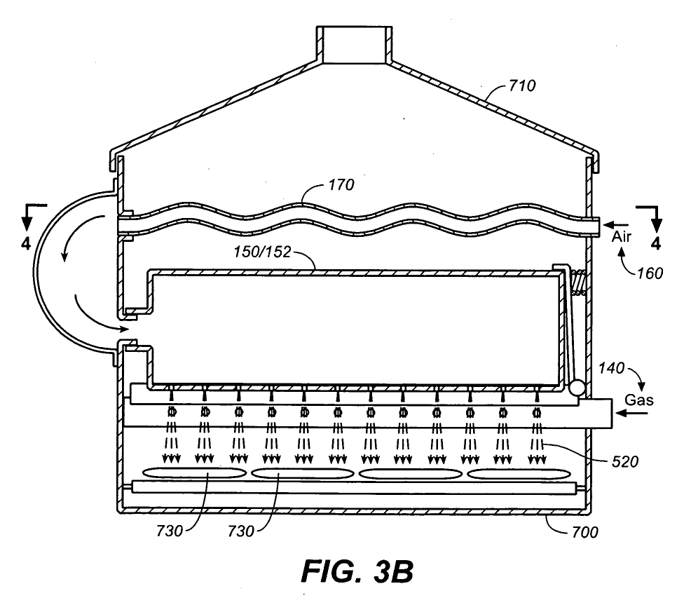

Referring first to FIGS. 1-4 illustrate the general structural and operative elements of the first preferred embodiment of the inventive apparatus. In its most essential aspect, the invention comprises, in the first instance, a heating element, which in a first preferred embodiment is a cylindrical pipe 110, having a first and second generally linear and parallel arrays 120 (second not shown) of gas orifices 130 on each side of the lower portion of the pipe. As noted previously, the orifices need not be parallel and may be disposed in any of a number of suitable configurations along all or only a portion of the burner. The gas pipe is in fluid communication with a gas fuel source 140 (FIG. 3B).

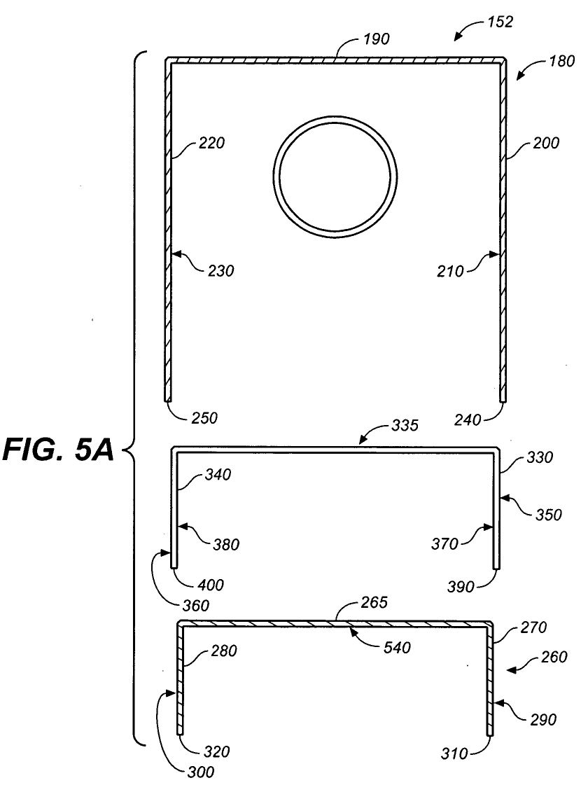

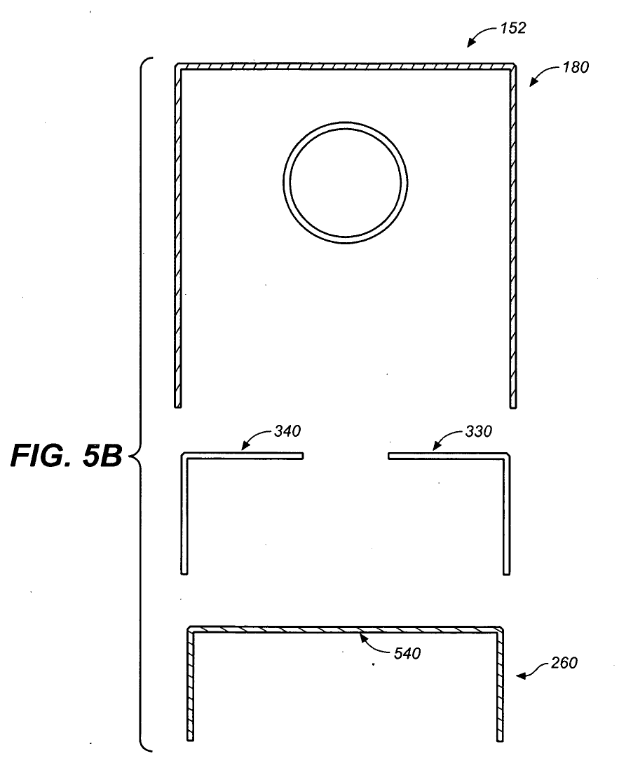

Next, the gas burner system includes an air plenum 150/152 in communication with a source 160 (FIG. 3B) of pressurized air through an air inlet pipe 170. In a first preferred embodiment (FIGS. 1B, 5A, and 5B), the air plenum 152 includes three principal structural elements, the first comprising an upper channel 180 which is substantially an inverted U-shaped length of formed stainless steel. The upper channel includes a top side 190, a right side 200 having an interior surface 210, and a left side 220 having an interior surface 230, and right and left lower edges 240, 250.

Next, and referring still to FIGS. 1B, 5A-B), the air plenum includes a lower inverted U-shaped channel 260 having an upper side 265, and right and left sides, 270, 280, each having exterior surfaces 290, 300, respectively, and right and left lower edges 310, 320.

Referring next to FIGS. 5A through 8, shown interposed between the upper channel and the lower channel are right and left L-shaped nozzle plates 330, 340. These plates may comprise separate channels, as shown in FIG. 5B, or comprise the downward right and left bends in a unitary U-shaped channel 335 (FIG. 5A). In either case, the nozzle plates each include an exterior side 350, 360 and an interior side 370, 380, right and left lower edges 390, 400, and an array of nozzles 410, which are orifices cut into the plates and shaped to accelerate air flow from the upper portion 420 of the nozzle to the outlet 430. The orifice cut extends across and along the bend line 440 generally running longitudinally along the midline the nozzle plate. As such, the air volume inside the air plenum is in fluid communication with the outside atmosphere through the upper portion of the nozzle orifices and the nozzle outlets. In manufacture, the bend is formed after the nozzles are themselves formed for ease of manufacture.

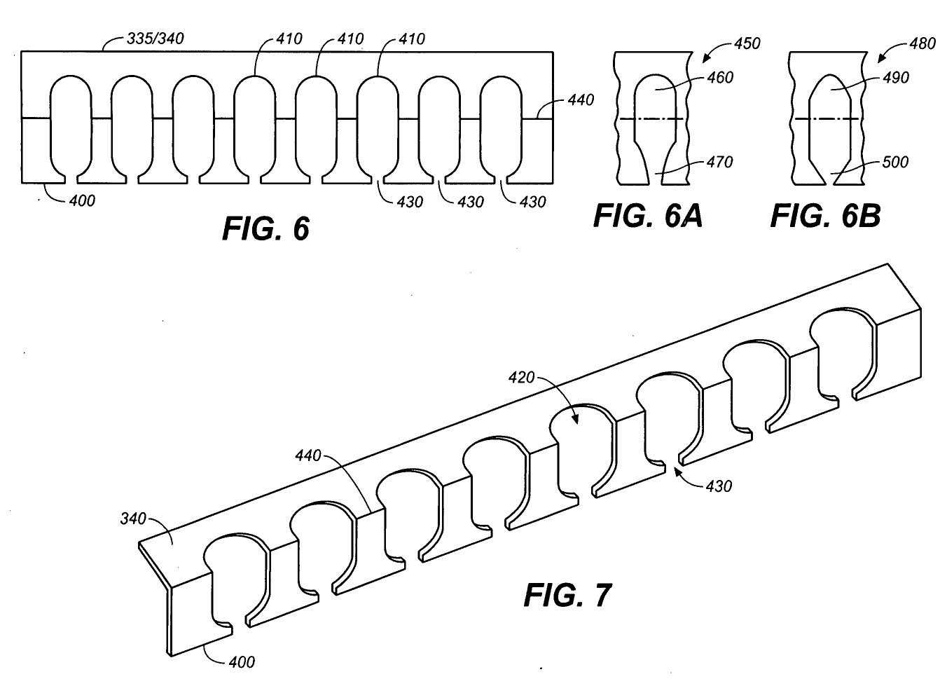

The nozzle shape can be varied according to the fluid flow characteristics desired, and tests to date have shown utility in generally oval shaped nozzles (FIG. 6). However, and referring now to FIG. 5A, a suitable alternative design 450 may include a hemispherical upper portion 460 and a funicular lower portion 470; or, now referring to FIG. 6B, a nozzle 480 having an arched upper portion 490 and a V-shaped lower portion 500.

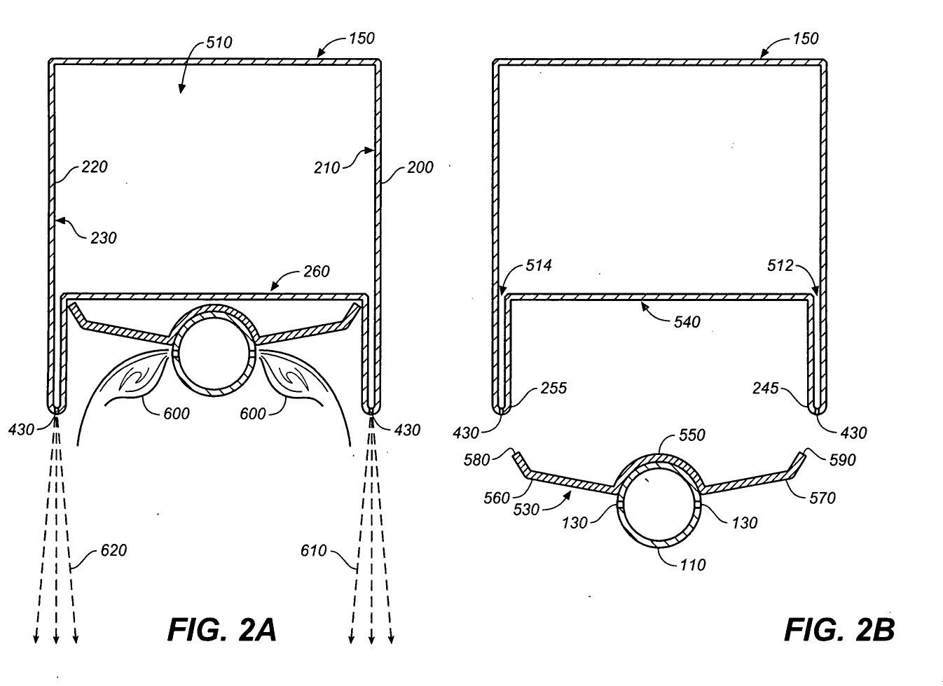

Referring next to FIGS. 2A and 2B, in a second preferred embodiment of the present invention, the air plenum 150 includes integral upper and lower U-shaped channel portions 180, 260, respectively. They are formed from a single sheet of metal, thus obviating the need for nozzle plates. Instead, bends 245, 255 at each of the lower right and left sides form right and left narrow air gaps or troughs 512, 514, through which air from the plenum 510 will pass for discharge through the linear array of air outlets 430 disposed along the length of each bend.

In either of the preferred embodiments of the air plenum, end caps 175, 185, are sealingly disposed at each end of the upper and lower channels.

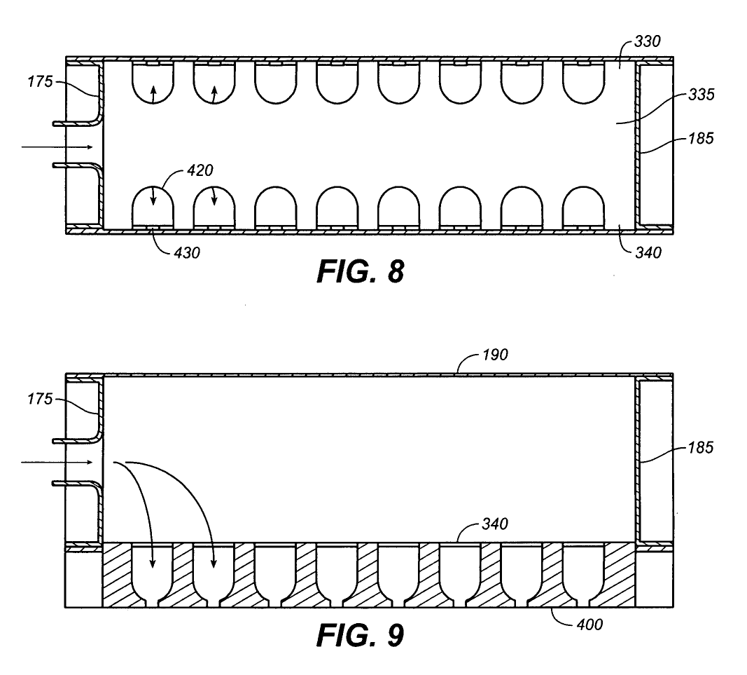

Referring again to FIGS. 2A and 2B, 5A and 5B, as well as FIGS. 8 and 9, in the assembled unit, the right and left exterior sides 350, 360 of the nozzle plates 330, 340 approximate and sealingly engage the right and left interior sides 210, 230 of the upper channel and the right and left exterior sides 290, 300 of the lower channel 260 approximate and sealingly engage the right and left interior sides 370, 380 of the nozzle plates. The lower edges of each plenum element are aligned to form a plane. Accordingly, the interior air volume 510 of the air plenum is brought into fluid communication with the surrounding atmosphere through the nozzles, and when pressurized air is delivered into the air plenum, an air flow pattern 520 is formed that is well adapted for guiding and focusing heat and flames downwardly and toward cooking food product disposed on either a stationary or moving surface below.

To further enhance cooking efficacy, the inventive apparatus may optionally include a wing or shroud 530 interposed between the gas burner pipe 110 and the underside 540 of the lower channel 260. This shroud complements the underside of the air plenum to function as a radiant heat reflector cap and comprises a medial channel portion 550 which is disposed over the top portion of the gas pipe. Angling from the edges of the channel portion are generally symmetrical wing elements 560, 570, which curve at their outboard ends 580, 590 (upwardly for shrouds on upper burners and preferably downwardly for lower burners). The curvature is initiated slightly above the level of the top of the gas burner element. This configuration helps to shape and control the shape of the flame and/or heat cone 600, but more importantly maximizes the production of radiant heat. Simultaneously, the moving air ejected from the air orifices in the plenum troughs creates an air guide or pair of focused forced air curtains 610, 620. This air curtain borders the flames on both sides and directs and focuses the flame and heat cone toward the food product moving on a cooking system conveyor.

It will be appreciated by those with skill in the art that the above-described wing or shroud may be dispensed with entirely and the air plenum itself may provide a significant and sufficient amount of radiant heating. Indeed, the downwardly depending trough portions of the plenum facilitate the focus and direction of radiant heat downwardly toward the food product. The shroud is provided to augment the radiant heating provided by the air plenum underside.

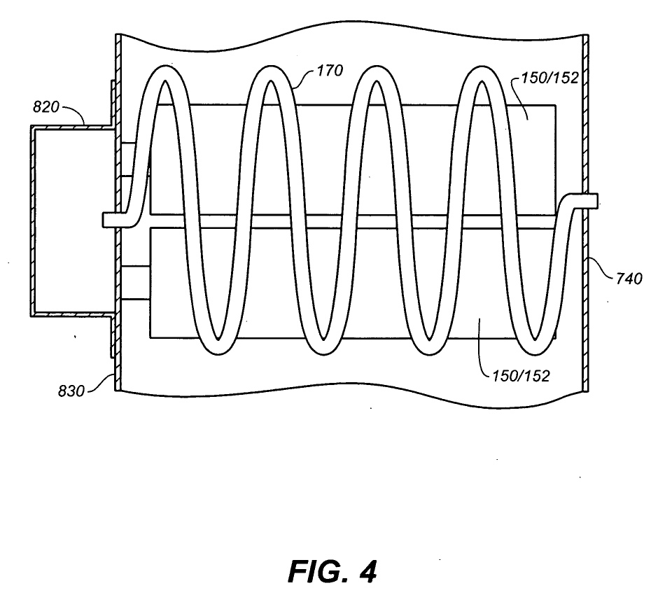

Referring next to schematic drawings FIGS. 3A through 4, when incorporated into an assembled broiling or cooking unit, the inventive apparatus is best implemented with snap in modular elements that facilitate cleaning and element replacement. Specifically, the system includes a housing base 700 and hood 710 which together define the cooking chamber (i.e., the cooking system interior volume). A product conveyor 720 is disposed in the lower portion for moving food product 730 from the cooking system housing front side, or inlet end of the system to and through the cooking system housing back side, or outlet end. It will be appreciated that in many cooking systems, there are burner or heating elements located below the moving food product as well as above the product, but the views shown herein are simplified to highlight the inventive features of the pressurized air system and heat/flame guide.

Pivotally attached to the interior side 730 of the cooking system housing right side 740 is a spring biased panel 750 having an upper finger 760 that engages the upper side 190 of the air plenum 150/152 when the latter is snapped into place in the cooking system. The spring 780 urges the plenum forward toward the front side of the cooking system so as to place a pipe 790 extending from the front end cap 175 into sealed connection with an air manifold pipe 800. Air from an air source 160 is conveyed through a heat exchange pipe 170, which is preferably disposed in a serpentine configuration in the upper portion of the cooking system so as to become preheated by heat from the burner elements. The pipe configuration may be varied according to the fluid flow characteristics of pressurized air through the pipe, the volume available for preheating, and the amount of preheating desired. A coiled or spiral rather than serpentine configuration, for instance, may be desirable. Heated air can also be drawn from the cooking chamber and then inserted back to the air plenum. Methods of this recirculation include blowing the heat back into the air plenum with one or more fans or inducing the heated air back into the pressurized plenum using a venturi injection system. The preheated air is introduced into an air manifold 820 attached to the left side 830 of the cooking system and through which air may be introduced into a plurality of air inlets and air plenums, the latter which may be disposed in a side-by-side relationship along the length of the cooking system interior. In this manner, the air plenums can be removed by grasping the cuboid device and pushing the spring biased panel backwards to disengage the plenum pipe 790 from the manifold pipe 800.

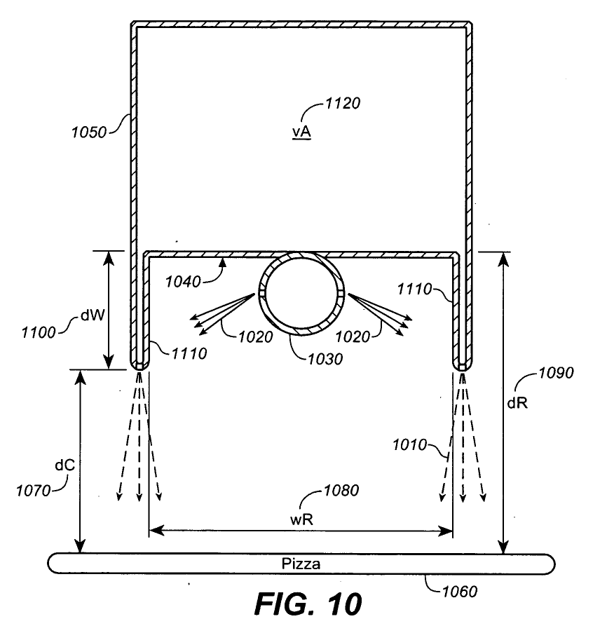

Referring now to FIG. 10, there is shown in a schematic cross-sectional end view the essential functional elements of the inventive system 1000 and highlighting its operative principles. This schematically distills the invention down to its essence for one possible configuration and combination of heating element and air plenum configuration. This shows that there are two principal sources of heating: (1) focused forced-convective heating primarily from air jets 1010 and secondarily from heat and/or flames 1020 from one or more heating elements 1030; and (2) radiant heat from the bottom surface 1040 of the air plenum 1050.

The influence of the focused forced-convention heating on food product (shown here as a pizza pie 1060), will depend on the volume and velocity of the forced air, the temperature of the forced air, and the distance 1070 to the food. The influence of radiant heat will depend on the temperature of the bottom surfaces of the plenum and burner, the width of the radiant area 1080, and the distance 1090 as measured from the radiant are to the food. Some foods will call for a higher proportion of convective heat in relation to radiant heat. Other foods may call for a higher proportion of radiant heat at the end of the cooking process in order to optimally finish the cooking. Accordingly, the length 1100 (1090 minus 1070) of the plenum wings 1110, will be tailored to achieve the desired proportion of radiant to convective heat.

The volume, vA 1120, of the air plenum can be varied according to the ideal length of time air should remain in the plenum before being ejected from the air nozzles. As illustration of this an air supply of 5 cfm has been found to be a suitable pressure for providing air that remains in the plenum for 8-10 seconds before ejection for a 16-24 inch long burner system. Other configurations, including the size of the air plenum 1120 will depend on the desired cooking performance and amount of heated air needed for recovery during high load-quantity cooking or for recovery time of a cooking system with an energy management system in energy savings or hibernation mode.

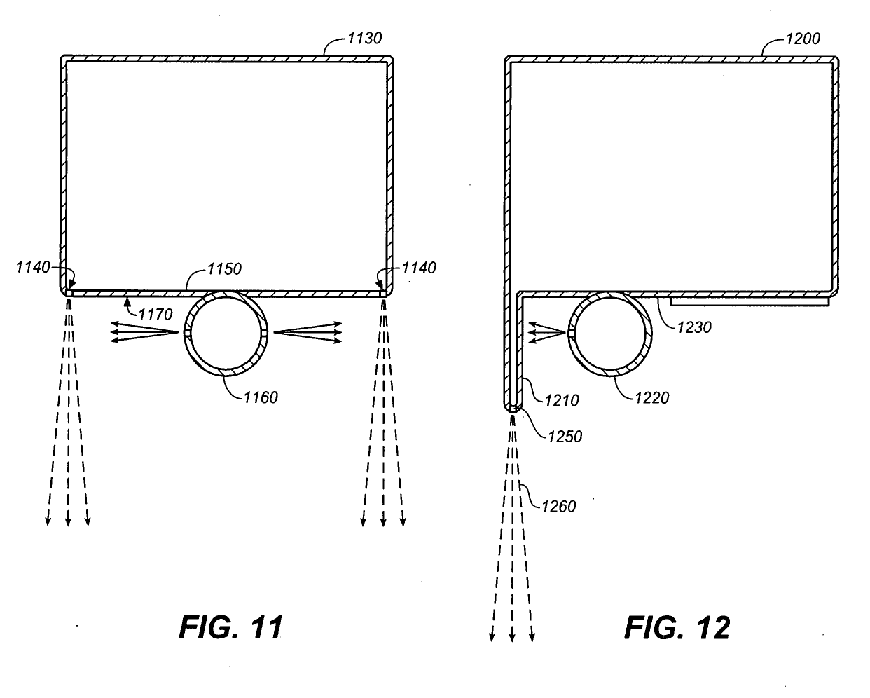

FIGS. 11-14 are each schematic cross-sectional end views in elevation showing alternative plenum configurations and air outlet arrays (here shown for use with gas burners.) FIG. 1 shows an embodiment in which the plenum 1130 is essentially square or rectangular in cross section and does not include wings, as shown in FIG. 10. Rather, the air outlets 1140 are disposed in the bottom side 1150 of the plenum and straddle the sides of the burner 1160, which is disposed proximate the bottom surface 1170 of the bottom side of the plenum. This produces an air curtain 1180 on both sides of the heating element.

FIG. 12 shows a plenum 1200 having a single wing 1210 disposed on one side of a burner element 1220 proximate the bottom surface 1230 of the plenum. This design is also applicable for use with electric heating elements. The burner may have gas outlets 1240 on only one side and orientated so as to face the wing, though outlets elsewhere may be provided, as well. The single wing with air nozzles 1250 provides a single air curtain 1260 on only one side of the heating element. Such burner/heating element design allow for an additional radiant heating section (right of 1230).

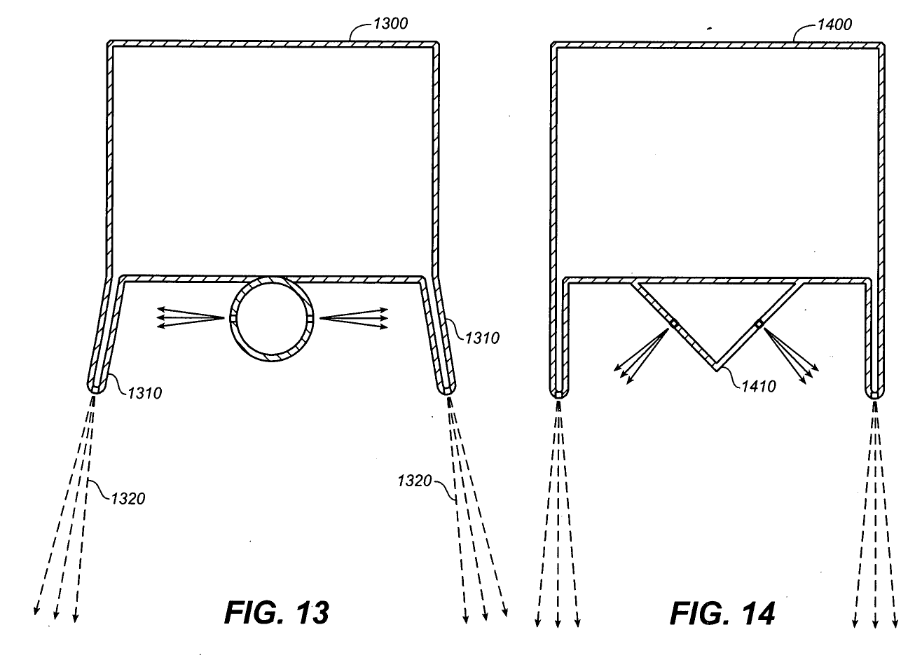

FIG. 13 shows another embodiment in which the air plenum 1300 has one or more outwardly angled wings 1310 (here shown outwardly), such that the air curtain is produced by jets 1320 that are alternately directed (here outwardly).

FIG. 14 shows yet another embodiment having the plenum 1400 of the first preferred embodiment, but in which the burner element 1410 is triangular, rather than circular, in cross section. Alternately, other geometric forms for the burners are possible—square, rectangular, and so forth.

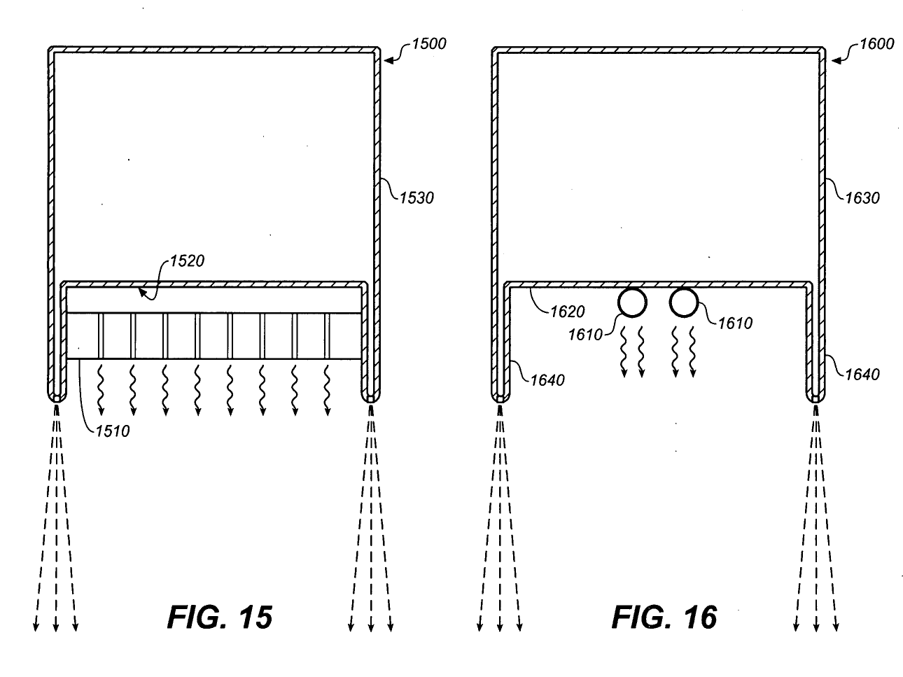

FIG. 15 shows still another embodiment 1500 in which an infrared heating element 1510 is provided on the underside 1520 of the plenum 1530.

FIG. 16 is still another embodiment 1600 having side-by-side parallel electric resistance heating elements 1610 disposed on the underside 1620 of an air plenum 1630 with wings 1640. This figure shows two heating elements, but singles or multiples are possible.

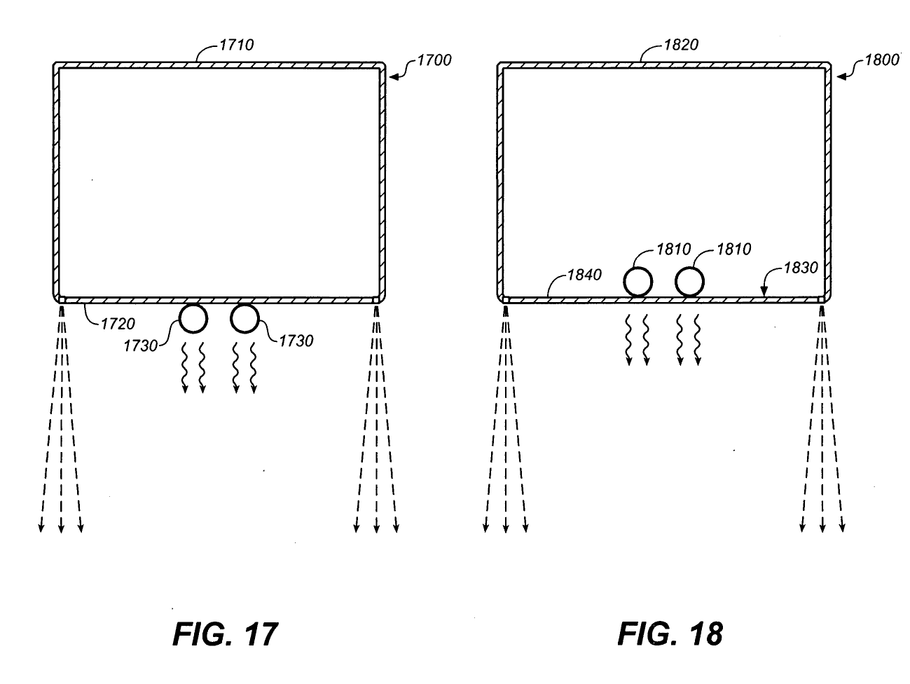

FIG. 17 shows a variation 1700 in which the air plenum 1710 has a flat bottom side 1720 with no wings and side-by-side parallel electric resistance heating elements 1730 (two shown, multiple or single possible) disposed under the bottom side. In yet another embodiment 1800, FIG. 18, the same apparatus is provided with electric heating elements 1810 disposed within the air plenum 1820 and proximate the top surface 1830 of the bottom side 1840 of the plenum. In this configuration, the heating element will directly heat the air in the air plenum.

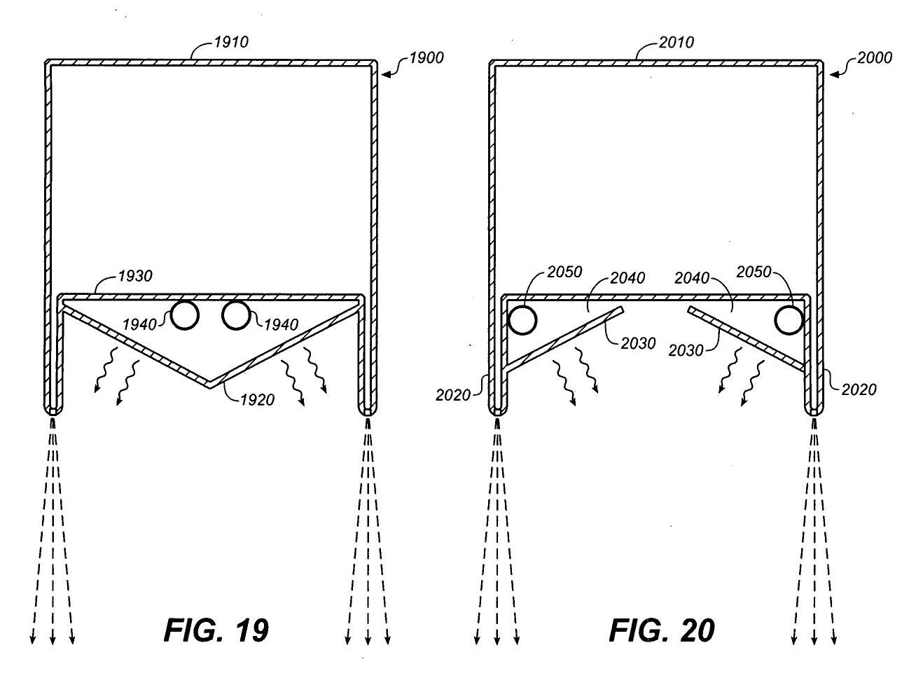

FIG. 19 shows another embodiment 1900 in which the air plenum 1910 is provided with an integral enclosure 1920 of triangular cross section on its bottom side 1930 and in which heating elements 1940 are disposed. Other geometric forms are possible.

FIG. 20 shows still another embodiment 2000 in which the air plenum 2010 includes wings 2020, each having an upwardly angled panel 2030 defining a space 2040 in which at least one heating element 2050 is disposed.

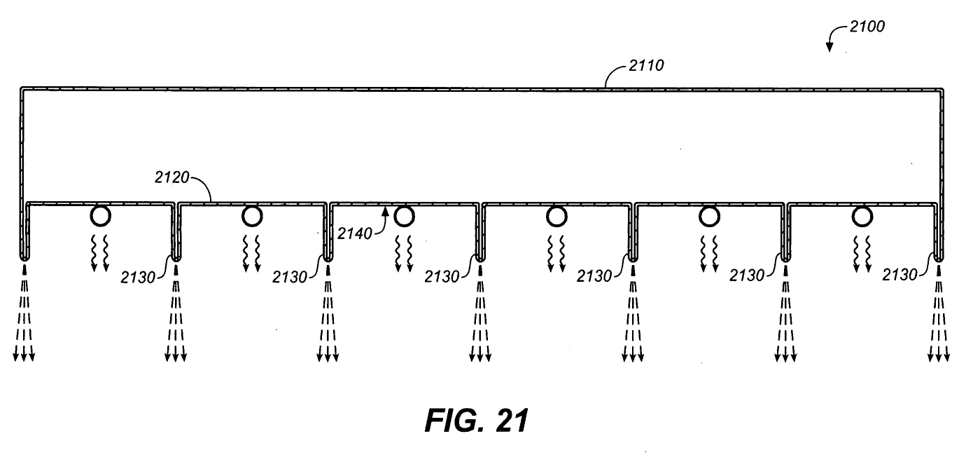

FIG. 21 is an alternative embodiment 2100 having an air plenum 2110 with an air outlet manifold disposed on its underside 2120. The manifold comprises a plurality of parallel wings 2130 integrally formed in the bottom side of the plenum. According to this embodiment, a plurality of air curtains are formed around a plurality of heating elements, each disposed proximate the bottom surface 2140 of the bottom side of the plenum. This embodiment would allow the use of angled wings or no wings, multiple burners and heating elements and so forth, as described above.

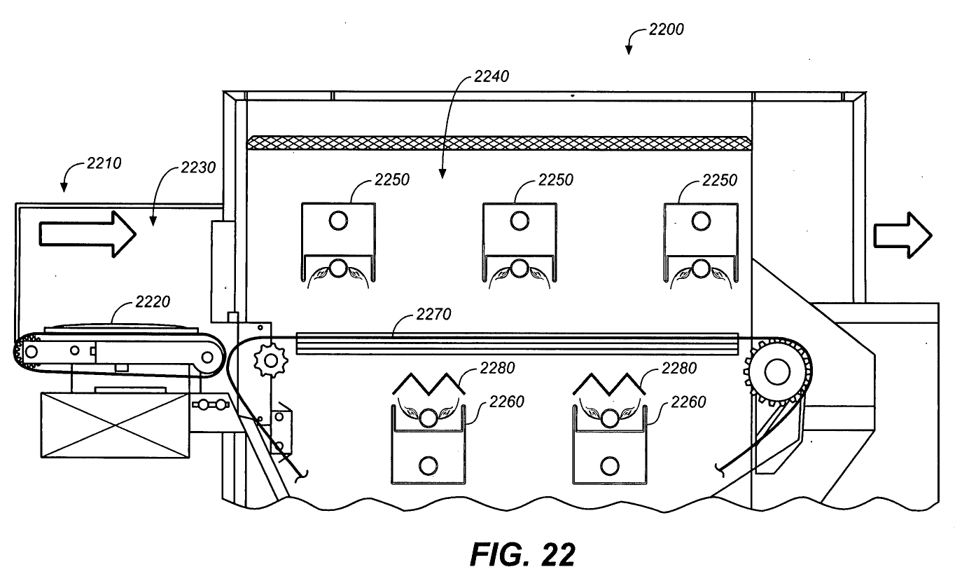

FIG. 22 is a cross-sectional side view in elevation of a possible heating element and pressurized air plenum configuration installed in a multistage conveyor oven using magnetic induction, convection and radiant heat. The upper and lower burners or heating elements in the cooking chamber can be aligned on top of each other or off-centered (here shown as single gas burners, off-centered). Here there is shown a conveyor oven 2200 having a first cooking stage 2210 utilizing a magnetic induction cooking element 2220 in the initial cooking chamber 2230. In the main cooking chamber 2240, food passes underneath one or more upper air plenum/heating element combinations 2250, and over one or more lower air plenum/heating element combinations 2260, which may be generally aligned with the upper elements or offset to varying degrees. The conveyor 2270 may be protected from the lower heating elements by shrouds 2280 disposed immediately over the lower air plenum/heating element combinations.

As may be appreciated by those with skill in the art, the system described above combines three means of heat transfer, including forced convection heating, radiant heating, and convection heating. Furthermore, the system includes means of capturing and reusing heat that would otherwise be discharged as useless and environmentally damaging waste heat. Careful testing and evaluation of the above-described system demonstrate reliable and dramatic energy savings and reduced cooking time when compared with commercial systems in general use. In view of the environmental and economic advantages that follow from such savings, it is clear that the improved system of the present invention is neither anticipated nor obvious in view of prior art products.

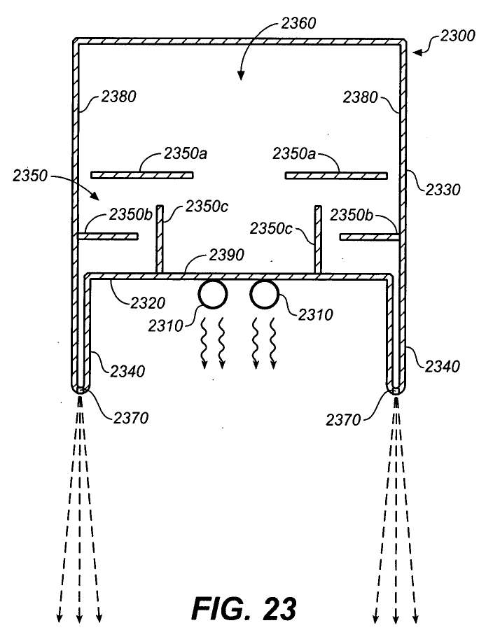

FIG. 23 shows yet another embodiment 2300 of the inventive system, this alternative including side-by-side parallel electric resistance heating elements 2310 disposed on the underside 2320 of an air plenum 2330 with wings 2340. This alternative further includes a baffle system 2350 disposed on the interior of one or more of the air plenums employed in the cooking system. For illustrative purposes this embodiment is shown with two resistance heating elements, but single or multiple electric heating elements may be employed, one or more gas burners may be employed, and any of the above-described plenum configurations may be employed. The baffle system impedes the direct flow of air from the interior volume 2360 of the plenum through the air outlets 2370, and thereby ensures that the air is retained in the interior volume a sufficient length of time to bring it up to a temperature suitable for its forced and focused ejection from the plenum. The baffles may include two horizontally disposed slats 2350a connected to each end plate (not shown) of the plenum, two horizontally disposed slats 2350b connected to the interior sides 2380 and end plates of the plenum, and two vertically disposed slats 2350c extending upwardly from the bottom side 2390 of the plenum. This configuration forces air to make an indirect patch from the plenum interior volume and through the spaces between the baffle slats before exiting the air outlets. Those with skill will appreciate that a suitable baffle might be configured with any of a number of different elements and configurations to provide the desired fluid flow characteristics, and such alternative designs are contemplated herein.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

1. A combination pressurized air system and heating element for use in a cooking system, comprising:
an air plenum having an interior volume in fluid communication with a source of pressurized air and having a plurality of air outlets for producing a plurality of air jets so as to form a curtain of focused forced air; and
a heating element disposed proximate said air plenum, such that said curtain of focused forced air guides and directs heat from said heating element in a predetermined direction.

2. The apparatus of claim 1, wherein said air plenum comprises a box having a top side, a right side, a left side, and a bottom side; and
wherein said heating element is disposed proximate said bottom side.

3. The apparatus of claim 1, wherein said air plenum includes integral parallel wings forming air troughs with air outlets disposed in the bottom of said troughs;

4. The apparatus of claim 3, wherein said heating element is positioned between said parallel wings and proximate said bottom side of said plenum, such that said plenum provides radiant heating during cooking and forced air released through said air outlets forms curtains that contain and guide the heat provided by said heating element.

5. The apparatus of claim 1, further including a reflective shroud interposed between said heating element and said air plenum to augment radiant heating produced in the cooking system.

6. The apparatus of claim 1, wherein said air plenum is generally rectangular in cross section.

7. The apparatus of claim 1, wherein said air plenum further includes a baffle system disposed in said interior volume.

8. A heating apparatus for broilers, toasters, and ovens, comprising:
at least one heating element; and
at least one air plenum having a plurality of air outlets disposed in an array on at least one side of said heating element such that pressurized air exiting said air outlets is focused and forced outwardly from said air plenum so as to define a curtain of moving air on said at least one side of said heating element that guides and directs heat from said heating element in a predetermined direction and toward food product.

9. The apparatus of claim 8, wherein said at least one air plenum is in communication with a source of pressurized air.

10. The apparatus of claim 8, wherein said heating element is a gas pipe having a plurality of gas orifices.

11. The apparatus of claim 10, wherein said plurality of gas orifices are disposed in at least one generally linear array.

12. The apparatus of claim 11, wherein said plurality of gas orifices are disposed in two generally parallel linear arrays.

13. The apparatus of claim 8, further including nozzles disposed proximate the air outlets, said nozzles shaped to accelerate low pressure air immediately before it exits an air outlet.

14. The apparatus of claim 8, wherein said at least one air plenum includes at least one reflective radiant side, and wherein said heating element is disposed proximate said reflective radiant side.

15. The apparatus of claim 14, further including a radiant shroud interposed between said heating element and said at least one reflective radiant side.

16. The apparatus of claim 8, wherein said at least one air plenum is connected to a source of pressurized air through an air inlet pipe, and wherein said system further includes a cooking system housing with interior sides and said at least one air plenum is removably installed in a snap-in quick release and installation apparatus disposed on at least one interior side of said housing such that said at least one air plenum can be rapidly removed and reinstalled.

17. The apparatus of claim 16, wherein said snap-in quick release and installation apparatus comprises hanging brackets on opposing interior sides of said cooking system housing and a spring to urge said at least one air plenum into a sealed connection to said air inlet pipe.

18. The apparatus of claim 16, wherein said cooking system includes a plurality of air plenums, each of said air plenums in fluid communication with an air manifold interposed between said source of pressurized air and said plurality of air plenums.

19. The apparatus of claim 18, wherein said air manifold is in communication with said source of pressurized air through a heat exchange pipe disposed in the interior of said cooking system housing, such that air passing through said heat exchange pipe is preheated before entering said air manifold.

20. The apparatus of claim 18, wherein each of said air plenums is generally rectangular in cross section and said plurality of air plenums are disposed in a side-by-side orientation in said cooking system housing.

21. The apparatus of claim 8, wherein said at least one air plenum includes a single integral wing having a generally linear array of air outlets and wherein said heating element is positioned to one side of said wing.

22. The apparatus of claim 8, wherein each of said air plenums includes two wings, each having a generally linear array of air outlets, and wherein said heating element is positioned between said wings.

23. The apparatus of claim 22, wherein said wings angle outwardly from said at least one air plenum such that the curtain of focused forced air angles outwardly from said at least one air plenum.

24. The apparatus of claim 8, wherein said at least one air plenum includes an integral enclosure in which at least one heating element is disposed.

25. The apparatus of claim 8, wherein said at least one air plenum includes a bottom side and an air outlet manifold disposed proximate said bottom side, and said air outlet manifold comprises a plurality of parallel wings integrally formed in said bottom side, and at least one heating element disposed between each pair of adjoining wings, such that a plurality of air curtains are formed around each of said heating elements.

26. The apparatus of claim 8, wherein said at least one air plenum further includes a baffle comprising slat members that cooperate to impede the direct flow of air from the interior volume of said at least one air plenum through the air outlets.
